(19) United States
(12) Patent Application Publication
(10) Pub. No.: US 2024/0059611 A1
(43) Pub. Date: Feb. 22, 2024

(54) ADMIXTURE FOR FLUIDIFYING A CEMENTITIOUS COMPOSITION WITH REDUCED CEMENT CONTENT

(71) Applicant: CHRYSO, Courbevoie (FR)

(72) Inventors: Bruno PELLERIN, Avon (FR); Mickaël HERVE, Courcelles le Roi (FR); Claire GIRAUDEAU, Saint-Cheron (FR); Lucia FERRARI, Orsay (FR); Vanessa KOCABA, Creteil (FR)

(21) Appl. No.: 18/266,575

(22) PCT Filed: Dec. 10, 2021
(86) PCT No.: PCT/EP2021/085256

§ 371 Date: Jun. 9, 2023

(30) Foreign Application Priority Data
Dec. 11, 2020 (FR) 2013093

(51) Int. Cl. C04B 24/26; C04B 14/10; C04B 28/04; C04B 28/14; C04B 24/06; C04B 24/12; C04B 24/00

(52) U.S. Cl. CPC C04B 24/2605; C04B 14/10; C04B 28/04; C04B 28/14; C04B 24/2641; C04B 24/06; C04B 24/122; C04B 24/003; C04B 2103/22

(57) ABSTRACT

The application describes an admixture comprising a polymer as fluidifier of a cement composition comprising:
from 20 to 64 wt. % clinker,
from 5 to 60 wt. % activated clay,
from 0 to 35 wt. % limestone,
from 0 to 10 wt. % calcium sulfate,

the proportions being relative to the dry weight of the cement composition.

The present invention relates to the use of an admixture for improving the fluidity retention of a cement composition having reduced clinker content, to an admixed cement composition and to uses thereof.

Usual cement compositions comprise a high proportion of clinker. For example, a cement composition conforming to standard NF EN 197-1 de 2012 comprises at least 65% by weight of clinker.

It is sought to lower the clinker content of cement compositions to reduce the carbon impact thereof, whilst maintaining their mechanical and rheological properties. Novel cement compositions in which part of the clinker is replaced by activated clays and limestone are beginning to emerge.

Patent application WO 2010/130511 describes a cement composition comprising activated clay.

One of the obstacles to the development of said compositions is that the lowering of the clinker content leads to deteriorated retention of the fluidity of the cement composition. Most admixtures known to improve the fluidity retention of a cement composition having a usual cement content do not exhibit sufficient performance for improving the fluidity retention of a cement composition which has a reduced cement content.

Application WO 2010/040915 teaches that the addition of a specific water-soluble cationic polymer to a hydraulic composition comprising calcined clays and optionally a plasticizer allows an improvement in the retention of workability.

Application WO 2019/094060 describes a cement composition comprising:
from 30 to 95% by weight of hydratable cement, limestone, or mixtures thereof;
from 5 to 70% by weight of calcined clay comprising from 1 to 15% by weight of Fe₂O₃,
from 0.002 to 0.2% by weight of a tertiary alkanolamine,
   the proportions being relative to the dry weight of the cement composition. The tertiary alkanolamine allows improved pozzolanic reactivity of the activated clay and thereby improved retention of fluidity at early and later ages.

There is a need to develop alternative methods for improving the fluidity retention of cement compositions having a reduced clinker content.

It is one of the objectives of the present application to provide an admixture that can be used as a fluidifier of said cement compositions.

It is a further objective to provide a composition with low clinker content and comprising activated clays having mechanical and rheological properties allowing use thereof as a cement composition.

A first subject of the invention concerns the use of an admixture comprising a polymer comprising units of following formulas (I) and (II):

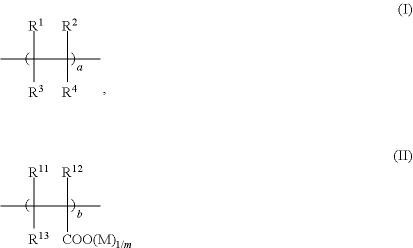

where:
R¹ and R² are each independently a hydrogen or a methyl,
R³ is a hydrogen or a group of formula —COO(M)_{1/m}
R⁴ is a group of formula —(CH₂)ₚ—(OAlk)_{q}—R⁵ where:
   p is 1 or 2,
   q is an integer of 3 to 300,
   the Alk of each OAlk unit of the group —(OAlk)_{q}— is independently a linear or branched allylene having 2 to 4 carbon atoms
   R⁵ is —OH or a linear or branched alkoxyl having 1 to 4 carbon atoms,
R¹¹ and R¹² are each independently a hydrogen or a methyl;
R¹³ is a hydrogen or a group of formula —COO(M)_{1/m},
M is H or a cation of valence m,
when M is H, m is 1 and when M is a cation, m is the valence of the cation M,
a is a number from 0.05 to 0.25, such that (100×a) represents the molar percentage of units of formula (I) within the polymer, and
b is a number from 0.75 to 0.95, such that (100×b) represents the molar percentage of units of formula (II) within the polymer,
   as fluidifier of a cement composition comprising:
from 20 to 64% by weight of clinker,
from 5 to 60% by weight of activated clay,
from 0 to 35% by weight of limestone,
from 0 to 10% by weight of calcium sulfate,
   the proportions being relative to the dry weight of the cement composition.

The following embodiments for formulas (I) and (II) of the units of the polymer can be considered each independently or combined with each other:
R¹ is H,
R³ is H,
R¹ and R³ are H,
R² is a methyl,
p is 1,
Alk is —CH₂—CH₂—, —CH₂—CH₂—CH₂—, —CH₂—CH₂—CH₂—CH₂—, —CH₂—CHMe—, —CHMe—CH₂—,
at least 80% of Alk in the group —(OAlk)_{q}— represent —CH₂—CH₂—, even all the Alk in the group —(OAlk)_{q}— represent —CH₂—CH₂—,
q is an integer of 5 to 200, in particular of 10 to 100, preferably of 25 to 75,
R⁵ is —OH or —OMe, preferably R⁵ is —OH,
the sum of a and b is 1,
R¹¹ is H,
R¹³ is H,
R¹¹ and R¹³ are H,
R¹² is H, and/or
M is H or a monovalent or bivalent cation, m then being 1 or 2, the monovalent cation preferably being selected from among an ammonium salt NH₄⁺, a primary, secondary, tertiary or quaternary ammonium cation, and a cation of an alkali metal such as a sodium, lithium or potassium ion, and the bivalent cation preferably being a cation of an alkaline-earth metal such as a magnesium or calcium ion;
a is a number from 0.05 to 0.20, preferably a is a number of between 0.10 and 0.20,
b is a number from 0.80 to 0.95, preferably b is a number between 0.80 and 0.90.

Preferably, the units of formula (I) of the polymer have the following formula (I′):

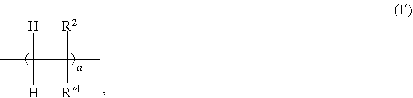

where:
R² is independently a hydrogen or a methyl, preferably a methyl,
R′⁴ is a group of formula —CH₂—(O—CH₂—CH₂)_{q}—R₅ where:
   q is an integer of 3 to 500,
   R⁵ is —OH or —OMe, preferably —OH,
   a is a number from 0.05 to 0.25, such that (100×a) represents the molar percentage of units of formula (I′) within the polymer.

Preferably, the units of formula (II) of the polymer have the following formula (II′):

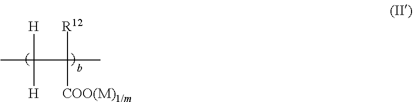

where:
R¹² is a hydrogen or a methyl, preferably a hydrogen,
M is H or a cation of valence m,
when M is H, m is 1 and when M is a cation, m is the valence of the cation M,
b is a number from 0.75 to 0.95, such that (100×b) represents the molar percentage of units of formula (II′) within the polymer.

Preferably, the polymer of the admixture used comprises units of formulas (I′) and (II′).

The following embodiments for formulas (I′) and (II′) of the polymer of the admixture can each be considered independently or combined with each other:
q is an integer of 5 to 200, in particular of 10 to 100, preferably of 25 to 75,
R⁵ is —OH or —OMe, preferably R⁵ is —OH,
a is a number from 0.05 to 0.20, preferably a is a number between 0.10 and 0.20,
b is a number from 0.80 to 0.95, preferably b is a number between 0.80 and 0.90,
the sum of a and b is 1 (which implies that the polymer is composed of units of formulas (I) and (II)), and/or
M is H or a monovalent or bivalent cation, m then being 1 or 2, the monovalent cation preferably being selected from among an ammonium salt NH₄⁺, a primary, secondary, tertiary or quaternary ammonium cation, and a cation of an alkali metal such as a sodium, lithium or potassium ion, and the bivalent cation preferably being a cation of an alkaline-earth metal such as a magnesium or calcium ion.

The polymer may comprise one or more additional units, in addition to those of formula (I) and (II). Preferably, the polymer is free of a unit of following formula (V):

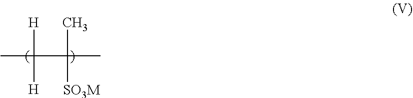

where M is H or a cation such as sodium. In particularly preferred manner, the polymer is free of sulfonic and sulfonate acid groups.

Preferably, the polymer of the admixture used is composed of the units of formulas (I) and (II). It does not comprise an additional unit in addition to those of formulas (I) and (II). The sum of a and b is then 1.

The weight average molecular weight of the polymer is generally from 10 000 to 200 000 g/mol, in particular from 10 000 to 100 000 g/mol.

In general, the polymer is obtained by free radical polymerization.

The polymer used is therefore a comb polymer having pendant groups linked to the main carbon chain by ether groups. The inventors have observed that the polymer such as defined above is capable of fluidifying a cement composition comprising:
from 20 to 64% by weight of clinker,
from 5 to 60% by weight of activated clay,
from 0 to 35% by weight of limestone,
from 0 to 10% by weight of calcium sulfate,
   the proportions being relative to the dry weight of the cement composition. This polymer in particular allows more efficient fluidification of said cement composition than a comb polymer having pendant groups linked to the main carbon chain by ester groups.

In addition, the inventors have observed that a polymer having a molar percentage of units of formula (I) of 5 to 25% (a is therefore from 0.05 to 0.25), in particular of 5 to 20 % (a is therefore from 0.05 to 0.20), preferably of 10 to 20% (a is therefore from 0.10 to 0.20), is a fluidifier of said cement compositions exhibiting better performance than when this molar percentage is higher.

The admixture comprising the polymer defined in the application allows an increase in the retention of fluidity (also called workability retention) of a cement composition such as defined above. Workability retention can notably be measured using a rheometer and by performing several measurements of the stress applied to obtain each value of strain rate. Preferably, the admixture allows an improvement in the fluidity retention of the cement composition over a time longer than or equal to 90 minutes, in particular longer than 120 minutes, even longer than 240 minutes.

The admixture is generally used so that the proportion of polymer is from 0.001% to 5% by weight, in particular from 0.005% to 1%, preferably from 0.01% to 0.2% by weight relative to the dry weight of the cement composition to be fluidified.

The admixture may further comprise a set retarding agent.

In the present application, by the term «set retarding agent» it is meant to designate a compound having the effect of delaying the setting of the cement composition i.e. of delaying or inhibiting phenomena related to this setting such as hydrating phenomena, and thereby inducing later hardening of the composition. In general, a set retarding agent delays the setting time of a cement composition to which it has been added at a dosage of no more than 5% by dry weight relative to the weight of the clinker, the setting time being measured following the EN480-2 (2006) test. Preferably, the setting time is delayed by at least 30 minutes compared with a reference cement composition.

The set retarding agent is particularly selected from among:
a carboxylic or hydroxycarboxylic acid in neutral form or a salt thereof, those having a pK_{A} de 2 to 5 being preferred. The carboxylic acid is particularly selected from among acetic acid, gluconic acid, citric acid, tartaric acid, malic acid, or a mixture thereof;
a phosphonic acid in neutral form or a salt thereof, selected in particular from among those comprising a group —N[—(CH₂)—PO(OH)₂]₂ or a group >C[—PO(OH)₂]₂, preferably selected from among amino tri methylene phosphonic acid (ATMP), ethylene diamine tetra methylene phosphonic acid (EDTMP), 1-hydroxyethylidene-1,1,-diphosphonic acid (HEDP), and the salts thereof, in particular the sodium salts.
a sugar, selected in particular from among glucose, gluconic acid in neutral form or a salt thereof, or in lactone form, dextrose, fructose, galactose, sucrose, maltose, lactose and mannose, and mixtures thereof,
a phosphate, selected in particular from among sodium tripolyphosphate and tetrapotassium pyrophosphate, and mixtures thereof,
and mixtures thereof.

The salt of carboxylic acid is preferably an alkali metal salt such as sodium, lithium or potassium, an alkaline-earth metal salt such as a salt of magnesium or calcium, or an ammonium salt NH₄⁺ or a salt of a primary, secondary tertiary or quaternary ammonium cation.

The preferred set retarding agent is a phosphonic acid in neutral form or a salt thereof, preferably one of those described above, gluconic acid in neutral form or a salt thereof, preferably sodium gluconate, or a mixture thereof. The inventors have observed that an admixture which, in addition to the above-defined polymer, comprises one of these preferred set retarding agents, allows more efficient fluidification of the cement composition defined in the application than other set retarding agents.

In general, within the admixture, the weight ratio of the polymer relative to the weight of the set retarding agent is from 1:2 to 2:1, preferably from 2:3 to 3:2.

The admixture used may further comprise a defoaming additive and/or an air-entraining additive, and one or more solvents such as water.

The admixture can be composed of the polymer as defined above and optionally a set retarding agent.

The cement composition to be fluidified by the admixture comprises:
from 20 to 64 weight %, preferably 35 to 60 weight % of clinker,
from 5 to 60 weight % of activated clay,
from 0 to 35 weight % of limestone,
from 0 to 10 weight % of calcium sulfate,
   the proportions being relative to the dry weight of the cement composition.

Said cement composition is not usual in that it has a low proportion of clinker and the proportion of activated clay is high. The cement composition is in particular of LC³ type («limestone calcined clay cement»), and/or it can be a CEM II/C-M Q-L or LL cement composition according to the provisional standard prEN 197-5.

The clinker is in particular Portland clinker, preferably Portland clinker such as defined in the publication «Cement Chemistry”, Harry F. W. Taylor. Edition, 2., Academic Press, 1990).

The cement composition comprises from 0 to 35 weight % preferably from 10 to 30 weight % of limestone, the proportions being by weight relative to the dry weight of the cement composition.

The limestone is preferably such as defined in the cement standard NF EN 197-1(2012) paragraph 5.2.6.

The cement composition comprises from 0 to 10 weight % preferably from 1 to 5 weight % of calcium sulfate, the proportions being by weight relative to the dry weight of the cement composition.

The calcium sulfate can be in dehydrate, hydrate form, or a mixture thereof. The calcium sulfate hydrate can be a monohydrate, a dihydrate or a mixture thereof. The calcium sulfate dihydrate of formula CaSO₄·2H₂O is gypsum. Gypsum is therefore an example of calcium sulfate.

By «activated clay», it is meant a clay that has been subjected to dehydroxylation. Such as used herein, the term «dehydroxylation» refers to the loss of one or more hydroxy groups (OH) in the form of water (H₂O) of a clay.

Preferably, the activated clay is kaolinic clay (also called kaolinitic) that has been activated. By «kaolinic clay», it is meant a clay which comprises kaolinite. A «kaolinic clay that has been activated» is a kaolinic clay in which at least part of the kaolinite has been dehydroxylated to metakaolin. For example, when heating the mineral kaolinite clay from 300 to 600° C., some water is lost according to the following reaction:

Al₂Si₂O₅(OH)₄→Al₂Si₂O₇+2H₂O

Therefore, a kaolinic clay that has been activated comprises and is even composed of metakaolin. Metakaolin is highly reactive in the presence of water and portlandite to form hydrate phases, in particular calcium alumina silicate hydrate (C—A—S—H) and strätlingite.

In the meaning of the application, the kaolinic clay that has been activated may comprise residual kaolinite (which was not dehydroxylated during activation) in an amount such as measured by thermogravimetric analysis (TGA) typically by temperature rise between 30 and 900° C. at a heating rate for example of 10° C./min, allowing quantification of the loss of mass corresponding to the water released by the clay. This content of residual kaolinite is generally less than or equal to 50 weight % , typically less than or equal to 40 weight %, in particular less than or equal to 30 weight % , preferably less than or equal to 20 weight %, and most preferably less than or equal to 10 weight % relative to the weight of the activated clay. Kaolinic clay that has been activated can be free of kaolinite (in which case dehydroxylation was complete).

Dehydroxylation can be performed by thermal, mechanical and/or chemical treatment.

Mechanical treatment for example can be the one described in the article «Preparation of pozzolanic addition by mechanical treatment of kaolin clay» Aleksandra Mitrović, Miodrag Zdujić. International Journal of Mineral Processing 132 (2014) 59-66.

Thermal treatment is by calcining, generally at a temperature of between 400 and 700° C. (dehydroxylation temperature). In this case it is kaolinic clay that has been calcined.

Calcining is most often carried out in a rotary kiln in which the clay is charged. The kaolin is at least partially converted to an amorphous and reactive phase having strong pozzolanic properties, called metakaolin. The calcined clay is then milled. Calcining can be conducted using the «flash» method whereby the clay is milled and the fine particles are calcined within a few seconds in a kiln.

Irrespective of the activation method used (in particular mechanical or thermal), the activated clay can be subjected to additional activation via chemical route by means of compounds capable of complexing cations, preferably compounds capable of complexing calcium.

The kaolinic clay that has been activated can be ARGICAL 1000 for example by AGS.

The cement composition may comprise one or more additives for example a defoaming additive, an air-entraining additive and/or a milling agent.

The milling agent may or may not be an alkanolamine.

Preferably, the cement composition comprises less than 0.001% in accumulated 5 weight of diethanol isopropanolamine (DEIPA), triisopropanolamine (TIPA), N,N-bis(2-hydroxypropyl) -N-(hydroxyethyl)amine (EDIPA) and triethanolamine (TEA) relative to the dry weight of the cement composition. In particularly preferred manner, the cement composition and/or the admixture are free of DEIPA, TIPA, EDIPA and TEA.

Preferably, the cement composition comprises less than 0.001 weight % of tertiary alkanolamine having 1 to 6 carbon atoms relative to the dry weight of the cement composition. The cement composition and/or the admixture are generally free of tertiary alkanolamine having 1 to 6 carbon atoms, even of alkanolamine having 1 to 6 carbon atoms, and even of alkanolamine.

Preferably, the cement composition and/or the admixture are free of cationic polymer having a cationic charge density greater than 0.5 meq/g and intrinsic viscosity lower than 1 dl/g, and are even free of cationic polymer. Intrinsic viscosity and cationic charge density are such as measured in application WO 2010/040915. The cationic charge density is measured by colloidal titration with an anionic polymer in the presence of a colour indicator sensitive to the ionicity of excess polymer. Measurements of the intrinsic viscosity of cationic polymers are performed in a 3 M NaCl solution, using a capillary viscometer of Ubbelhode type, at 25° C. In the capillary tube, the flow time is measured, between 2 marked points, of the solvent and of solutions of the polymer at different concentrations. Reduced viscosity is measured by dividing specific viscosity by the concentration of the polymer solution. The specific viscosity is obtained for each concentration, by dividing the difference between the flow times of the polymer solution and solvent, by the flow time of the solvent. By plotting the line of reduced viscosity as a function of the concentration of the polymer solution, a straight line is obtained. The intersection with the Y-axis of this straight line corresponds to the intrinsic viscosity for a concentration of zero.

In one embodiment, the cement composition is composed of:
from 20 to 64 weight % clinker,
from 5 to 60 weight % activated clay,
from 0 to 35 weight % limestone,
from 0 to 10 weight % calcium sulfate,
from 0 to 5 weight % milling agent,
from 0 to 5 weight % defoaming additive, and
from 0 to 5 weight % air-entraining additive,
   the proportions being relative to the dry weight of the cement composition.

Preferably, in the cement composition, the weight ratio of calcined clay weight relative to limestone weight is 1:2 to 5:1, preferably 1:1 to 3:1, more preferably 3:2 to 5:2.

Preferably, in the cement composition, the weight ratio of clinker relative to the weight of activated clay is 1:4 to 4:1, in particular 1:1 to 3:1, preferably 3:2 to 5:2.

Preferably, in the cement composition, the weight ratio of clinker weight relative to limestone weight is 1:1 to 10:1, in particular 3:1 to 5:1.

Preferably, the cement composition contains:
from 5 to 25 weight %, preferably from 6 to 20 weight % of Al₂O₃,
from 25 to 55 weight %, preferably from 40 to 50 weight % of CaO,
from 20 to 40 weight %, preferably from 22 to 35 weight % of SiO₂,
from 2 to 10 weight %, preferably from 2 to 5 weight % SO₃, and/or
from 0.1 to 10 weight %, preferably from 0.5 to 8 weight % of Fe₂O₃,
   relative to the sum of the dry weights of clinker, activated clay, limestone and calcium sulfate.

A second subject of the invention concerns an admixed cement composition comprising:
a cement composition comprising:
from 20 to 64 weight % clinker,
from 5 to 60 weight % activated clay,
from 0 to 35 weight % limestone,
from 0 to 10 weight % calcium sulfate,
   the proportions of clinker, activated clay, limestone and calcium sulfate being relative to the dry weight of the cement composition, and
the admixture such as defined above,
   the proportion of polymer in the admixture being from 0.001 weight % to 5 weight %, in particular from 0.005 weight % to 1 weight %, preferably from 0.01 weight % to 0.2 weight % relative to the dry weight of the cement composition.

In the meaning of the application, by «admixed cement composition» it is meant a composition comprising the cement composition such as defined above and the admixture such as defined above, and by «cement composition» it is meant the cement composition free of admixture (it is the cement composition to be fluidified).

The above-defined embodiments for the cement composition are applicable to the admixed cement composition.

The admixed cement composition may or may not comprise a milling agent. The milling agent may or may not be an alkanolamine.

Preferably, the admixed cement composition comprises less than 0.001% by accumulated weight of diethanol isopropanolamine (DEIPA), triisopropanolamine (TIPA), N,N-bis(2-hydroxypropyl)-N-(hydroxyethyl)amine (EDIPA) and triethanolamine (TEA) relative to the dry weight of the admixed cement composition. In particularly preferred manner, the admixed cement composition is free of DEIPA, TIPA, EDIPA and TEA.

Preferably, the admixed cement composition comprises less than 0.001 weight % of tertiary alkanolamine having 1 to 6 carbon atoms relative to the dry weight of the cement composition. The admixed cement composition is generally free of tertiary alkanolamine having 1 to 6 carbon atoms, and is even free of alkanolamine.

Preferably, apart from the admixture defined above, the admixed cement composition is free of an admixture which fluidifies and/or is likely to delay the setting of the admixed cement composition.

Preferably, the admixed cement composition is free of cationic polymer having a cationic charge density greater than 0.5 meq/g and intrinsic viscosity lower than 1 dl/g, and is even free of cationic polymer.

The admixed cement composition is preferably composed of the above-defined cement composition and the above-defined admixture.

Preferably the admixed cement composition pays heed to the criteria defined in standard ASTM C1157 of 2020.

A third subject of the invention concerns a method for improving the fluidity retention (also called workability retention) over time of a cement composition, comprising the contacting of the cement composition such as defined above with an admixture such as defined above. This improvement is preferably long-term, namely over a period longer than or equal to 90 minutes, in particular longer than 120 minutes, even longer than 240 minutes.

A fourth subject of the invention concerns a method for preparing the admixed cement composition, comprising the step of mixing the cement composition such as defined above, the admixture such as defined above, and water.

A fifth subject of the invention concerns the use of the above-defined admixed cement composition to prepare a hydraulic composition.

A sixth subject of the invention concerns a hydraulic composition comprising (even composed of) the admixed cement composition defined above, water, aggregate, and optionally one or more mineral additions. The hydraulic composition is preferably a concrete, mortar, or screed composition.

By «aggregate», it is meant as assembly of mineral particulate material having a mean diameter of between 0 and 125 mm. Depending on their diameter, aggregates are classified into one of the six following families: fillers, fine sand, coarse sand, gravel sand, gravel and ballast (standard XP P 18-545). The aggregates that are most used are the following:
fillers, having a diameter of less than 2 mm and for which at least 85% of the aggregate has a diameter of less than 1.25 mm and at least 70% of the aggregate has a diameter of less than 0.063 mm,
sands having a diameter of between 0 and 4 mm (in standard 13-242, the diameter possibly reaching 6 mm),
gravel-sand having a diameter greater than 6.3 mm,
gravel having a diameter of between 2 mm and 63 mm.
   Sands are therefore included in the definition of aggregate according to the invention. Fillers can be of lime or dolomitic origin in particular.

The expression «mineral additions» designates slags (such as defined in cement standard NF EN 197-1(2012) paragraph 5.2.2), basic oxygen furnace slag (BOF), pozzolanic materials (such as defined in cement standard NF EN 197-1(2012) paragraph 5.2.3), fly ash (such as defined in cement standard NF EN 197-1(2012) paragraph 5.2.4), calcined shale (such as defined in cement standard NF EN 197-1 (2012) paragraph 5.2.5), or fumed silicas (such as defined in cement standard NF EN 197-1(2012) paragraph 5.2.7 or standard prEN 197-5 paragraph 5), limestones or mixtures thereof.

The invention is illustrated in the following Examples and FIGURE.

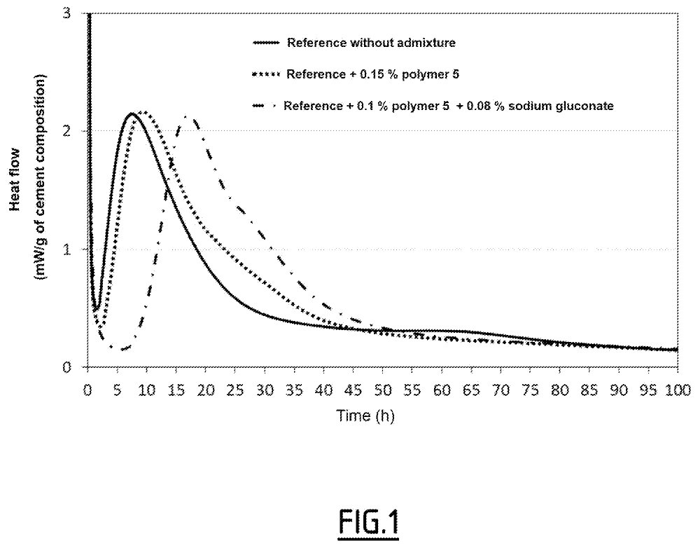

FIG. 1 illustrates the hydrating kinetics of a cement composition (heat flow in mW/g of cement composition as a function of time in hours):
of a cement composition without admixture (reference) (solid line),
of an admixed cement composition, the admixture comprising the polymer 5 at a dosage of 0.15 weight % relative to the dry weight of the cement composition (the admixed cement composition being free of set retarding agent) (dotted line), or
of an admixed cement composition, the admixture comprising the polymer 5 at 0.1 weight % and sodium gluconate at 0.08 weight % relative to the dry weight of the cement composition (chain-dotted line) (Example 3).

### EXAMPLE 1

Impact of the type of polymer and of the presence of a set retarding agent on the fluidification of a cement composition.

The polymers described below were tested on a mixture of cement composition and water (cement slurry). Rheological testing was carried out with a hydration time of 2 hours.

The cement composition used was composed of about 50% clinker and about 50% of a mixture of metakaolin, limestone and gypsum (Table 1).

TABLE 1
Mineralogical analysis by X-ray diffraction
of the cement composition used.

| Phase name | Formula | Weight content (%) |
|---|---|---|
| Alite | Ca₃SiO₅ | 25.3-32.7 |
| Belite | Ca₂SiO₅ | 5.7-15.2 |
| Aluminate | Ca₃Al₂O₆ | 0.3-2.5 |
| Ferrite | Ca₄Al₂Fe₂O₁₀ | 6.8-8.1 |
| Total clinker phases | | 37.6-59.1 |
| Calcium sulfate | | 7.6-8.1 |
| Quartz* | SiO₂ | 1.2-1.6 |
| Free lime* | CaO | 0.1-0.4 |
| Portlandite | Ca(OH)₂ | 0-1.3 |
| Calcite* | CaCO₃ | 13.5-15 |
| Aragonite* | CaCO₃ | 0.0-1.3 |
| Periclase* | MgO | 0.0-1.7 |
| Dolomite | CaMgCO₃ | 2.2-3.4 |
| Aphthitalite | K₃Na(SO₄)₂ | 0.0-0.5 |
| Thenardite* | Na₂SO₄ | 0.2-0.3 |
| Syngenite | K₂Ca(SO₄)₂ H₂0 | 0.0-0.7 |
| Mullite | Al₆Si₂O₁₃ | 1.8-2.0 |
| Hematite | Fe₂O₃ | 0.0-0.7 |
| Amorphous phases | | 16.2-17.4 |
| Kaolinite | Al₂Si₂O₅(OH)₄ | 2.7-3.4 |

### Description of the Polymers Used:

The polymers used in the Examples are comb polymers having pendant groups linked to the main carbon chain either by ether groups (polymers 5 and 6), or by ester groups (polymers 1 to 4 and 7).

The comb polymers having pendant groups linked to the main carbon chain by ether groups were obtained by free radical polymerization with HPEG 2400 and are composed of the units of following formulas:

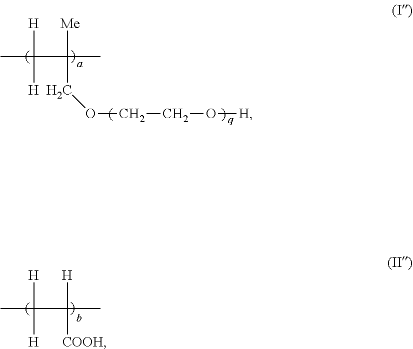

where a, b and q are such as defined in Table 2 below. The mean total number of units in the polymer is the sum of the mean number of units of formula (I″) and the mean number of units of formula (II″).

Polymer 5 is a polymer such as defined in the application.

The percentage in units of formula (I″) in polymer 6 is higher than 30%. It is therefore a comparative polymer.

The comb polymers having pendant groups linked to the main carbon chain by ester groups (comparative) were obtained by polymerization followed by post-esterification to graft the pendant groups, for example with MPEG 750 for polymer 7, or a MPEG mixture for polymers 1 and 4 (two values of «q» in Table 2 below). They are composed of the units of following formulas (XI) and (XII):

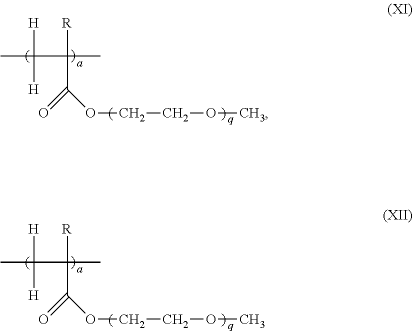

where R is H or a methyl.

The mean total number of units in the polymer is the sum of the mean number of units of formula (XI) and the mean number of units of formula (XII).

TABLE 2
q, a, b and mean total number of units in each
tested polymer, and preparation method.

| | Composed | | | | |
|---|---|---|---|---|---|
| | of the units | | | | Preparation |
| Polymer | of formulas | q | a* | b* | method |
| 1 (compar- | (XI) & (XII) | q1 = | 0.20 | 0.80 | Polymerization then |
| ative) | with R = Me | 114 = | | | post-esterification |
| | | q2 = 45 | | | |
| 2 (compar- | (XI) & (XII) | 17 | 0.25 | 0.75 | Polymerization then |
| ative) | with R = Me | | | | post-esterification |
| 3 (compar- | (XI) & (XII) | 45 | 0.20 | 0.80 | Polymerization then |
| ative) | with R = Me | | | | post-esterification |
| 4 (compar- | (XI) & (XII) | 31 | 0.40 | 0.60 | Polymerization then |
| ative) | with R = Me | q1 = 45 | | | post-esterification |
| | | q2 = 17 | | | |
| 5 (inven- | (I″) & (II″) | 50 | 0.18 | 0.82 | Free radical |
| tion) | | | | | polymerization |
| 6 (compar- | (I″) & (II″) | 50 | 0.33 | 0.67 | Free radical |
| ative) | | | | | polymerization |
| 7 (compar- | (XI) & (XII) | 17 | 0.47 | 0.53 | Polymerization then |
| ative) | with R = H | | | | post-esterification |

*determined by gel permeation chromatography (GPC). Whether during free radical polymerization or during post-esterification, a certain amount of residual monomer remains in solution after synthesis. These residual monomers can be quantified by GPC. The difference between this residual amount and the quantity of starting monomer is the quantity of monomer that has been polymerized and therefore a, after which b = 1 − a.

### Experimental Protocol:

The cement composition was prepared as follows using a KENWOOD KM011 CHEF TITANIUM mixer with stainless steel bowl (capacity 4.6 litres) and a metal K-shaped mixing paddle (height 13 cm and width 13.6 cm); the fluidity of the composition was measured as follows:
1. The water and admixture were weighed in the mixer bowl, and the mixer set in operation at a speed of 43 rpm.
2. The chronometer was started and the cement composition was added to the bowl in 30 seconds.
3. The speed was increased to 96 rpm and the mixture was mixed for one minute.
4. The mixer was stopped for 30 seconds, and any admixed cement composition sprayed onto the walls was scraped towards the centre with a spatula.
5. The admixed cement composition was mixed for one minute at 96 rpm.
   After mixing, the admixed cement composition obtained, which was in the form of a slurry, was poured into the cylindrical measuring cell of a Kinexus Pro (Netzsch) rheometer equipped with measuring geometry of vane type.

Five minutes after the start of mixing, the admixed cement composition was subjected to pre-shearing for one minute at a strain rate of 200 s⁻¹. The admixed cement composition was then subjected to a series of decreasing levels of strain rate on a logarithmic scale with steps of 200 to 0.01 s⁻¹ and the rheometer recorded the stress to be applied at each point. This allows a flow curve to be plotted, linking the stress applied to obtain each value of strain rate. These flow curves show a minimum stress which is interpreted as a threshold stress, namely a minimum stress to be applied to cause flowing. This value varies inversely to fluidity, it is therefore sought to reduce this value as much as possible.

Thereafter, the flow curve is measured every 30 minutes up to 120 min after the start of mixing, to check changes in fluidity over time.

In a first series of tests, the ratio of the weight of water to the weight of the cement composition (dry weight) was 0.45. The admixture was composed of one of the polymers (no set retarding agent). For each test, the proportion of polymer was 0.1 weight % relative to the dry weight of the cement composition to be fluidified. The results are given in Table 3.

TABLE 3
Threshold stress of the admixed cement composition
according to the type of polymer in the admixture.
Threshold stresses (Pa)

| Polymer | 5 min | 30 min | 60 min | 90 min | 120 min |
|---|---|---|---|---|---|
| 1 (comparative) | 6.7 | 19.2 | 37.2 | 45.9 | 54.3 |
| 2 (comparative) | 20.9 | 23.5 | 34.7 | 41.3 | 48.8 |
| 3 (comparative) | 11.4 | 22.6 | 35.0 | 42.6 | 49.7 |
| 4 (comparative) | 32.8 | 23.2 | 36.4 | 45.9 | 59.4 |
| 5 (invention) | 0.8 | 2.6 | 5.8 | 12.1 | 17.8 |

These results show that polymer 5 of the invention is by far the best fluidifier. It allows significant lowering of the initial threshold stress and improved fluidity retention of the admixed cement composition over a time of 120 minutes or longer.

In a second series of tests, the ratio of the weight of water to the weight of the cement composition (dry weight) was 0.35. The admixture was composed of polymer 5 (no set retarding agent). Having regard to the smaller quantity of water compared with the first series of tests, the dosage of polymer 5 was increased to 0.15 weight % relative to the dry weight of the cement composition to be fluidified, to obtain the desired threshold stresses. The results are given in Table 4 (line: «polymer 5»).

In a third series of tests, the ratio of the weight of water to the weight of the cement composition (dry weight) was maintained at 0.35. The admixture was composed of polymer 5 and a solution of sodium gluconate as set retarding agent. The dosage of polymer 5 was reduced to 0.10 weight % relative to the dry weight of the cement composition to be fluidified. The dosage of sodium gluconate was 0.08 weight % relative to the dry weight of the cement composition to be fluidified. The results are given in Table 4 (line: «polymer 5+sodium gluconate»).

TABLE 4
Threshold stress of the admixed cement
composition according to type of admixture.
Threshold stresses (Pa)

| Admixture | 5 min | 30 min | 60 min | 90 min | 120 min |
|---|---|---|---|---|---|
| Polymer 5 (invention) | 3.5 | 9.8 | 17.4 | 22.8 | 28.6 |
| Polymer 5 + sodium | 1.0 | 2.9 | 5.1 | 8.0 | 9.5 |
| gluconate (invention) | | | | | |

The results show that the addition of a set retarding agent allows an improvement in the fluidity of the admixed cement composition, even when reducing the dosage of polymer 5.

In a fourth series of tests, the ratio of the weight of water to the weight of the cement composition (dry weight) was maintained at 0.35. The admixture was composed of one of the polymers and a solution of sodium gluconate as set retarding agent. The dosage of the polymer was 0.125 weight % relative to the dry weight of the cement composition to be fluidified. The dosage of sodium gluconate was 0.1 weight % relative to the dry weight of the cement composition to be fluidified. The results are given in Table 5.

TABLE 5
Threshold stress of the admixed cement
composition according to type of admixture.
Threshold stresses (Pa)

| Admixture | 5 min | 30 min | 60 min | 90 min | 120 min |
|---|---|---|---|---|---|
| Polymer 5 + sodium | 5.2 | 4.8 | 4.9 | 4.8 | 5.4 |
| gluconate (invention) | | | | | |
| Polymer 6 + sodium | 76.8 | 57.1 | 95.8 | 115.1 | 120.7 |
| gluconate | | | | | |
| (comparative) | | | | | |
| Polymer 7 + sodium | 68.1 | 49.7 | 61.8 | 72.9 | 87.3 |
| gluconate | | | | | |
| (comparative) | | | | | |

These results show that an admixture comprising polymer 5 of the invention and sodium gluconate as set retarding agent is by far the best fluidifier compared with admixtures comprising other polymers and the same set retarding agent.

### EXAMPLE 2

Impact of the type of set retarding agent in the admixture on the fluidification of a cement composition.

Polymer 5 described above was tested with different set retarding agents on a cement composition to be fluidified. A rheological study with a hydration time of 2 hours was carried out.

The cement composition and the experimental protocol were the same as those described in Example 1.

The selected set retarding agents were conventional retarders used to reduce the hydrating kinetics of a cement. Among these, carboxylic acids (citric acid, tartaric acid, salicylic acid), a phosphonic acid in neutral form or a salt thereof, and a sugar of sucrose type were evaluated.

The ratio of the weight of water to the weight of the cement composition (dry weight) was 0.35. The admixture was composed of polymer 5 and the set retarding agent. The dosage of polymer 5 was 0.125 weight % relative to the dry weight of the cement composition to be fluidified. The dosage of set retarding agent was 0.1 weight % relative to the dry weight of the cement composition to be fluidified. The results are given in Table 6.

TABLE 6
Threshold stress of the admixed cement composition according to the type
of admixture comprising polymer 5 and a different set retarding agent.
Threshold stresses (Pa)

| Admixture | 5 min | 30 min | 60 min | 90 min | 120 min |
|---|---|---|---|---|---|
| Polymer 5 + | 5.2 | 4.8 | 4.9 | 4.8 | 5.4 |
| sodium | | | | | |
| gluconate | | | | | |
| Polymer 5 + | 5.9 | 49.0 | 76.7 | 71.4 | 68.8 |
| citric acid | | | | | |
| Polymer 5 + | 9.6 | 164.8 | 256.3 | 280.7 | 258.3 |
| tartaric acid | | | | | |
| Polymer 5 + | 70.7 | 111.2 | 92.1 | 81.0 | 78.1 |
| salicylic acid | | | | | |
| Polymer 5 + | 18.0 | 49.2 | 43.2 | 37.4 | 34.0 |
| sugar | | | | | |
| (sucrose) | | | | | |
| Polymer 5 + | 2.1 | 3.1 | 4.4 | 5.7 | 6.8 |
| phosphonic | | | | | |
| acid (ATMP) | | | | | |

These results show that the admixtures which, in addition to polymer 5, comprise sodium gluconate or the phosphonate allow better fluidification than those comprising other set retarding agents.

### EXAMPLE 3

Impact of admixtures on the hydrating kinetics of the cement composition.

Isothermal microcalorimetry tests (TAM Air calorimeter, TA Instruments) allowed evaluation of the impact of the admixtures on the hydrating kinetics of the cement composition. Since hydration of the cement composition is an exothermal reaction, isothermal calorimetry allows the obtaining of changes in the flow of heat released per gram of the cement composition as a function of time.

The cement slurry was prepared from a mixture of cement material, admixtures and water. A water-to-binder ratio (W/B) of 0.35 was determined for all the slurries. The agitation system was composed of a turbine agitation paddle (diameter 2.5 cm) attached to an IKA mixer, and a 50 mL stainless steel beaker. The admixtures and water were first weighed and mixed in the stainless steel beaker. The water contributed by the admixture was subtracted from the mixing water. The cement composition powder was added to the water, this addition marking the start of hydration. The suspension was mixed for one minute at a speed of 500 rpm. Mixing was then stopped and the edges of the beaker and the paddle were scraped for one minute. Finally, agitation was restarted at a speed of 1000 rpm for one minute. The cement slurry was then ready for the analyses.

To reproduce the same experimental conditions as those for the rheological tests, the cement slurries were prepared:
without admixture (reference),
with polymer 5 at a dosage of 0.15 weight % relative to the dry weight of the cement composition (without set retarding agent), or
with a mixture of polymer 5 at 0.1 weight % and sodium gluconate at 0.08 weight % relative to the dry weight of the cement composition.
   The results are given in FIG. 1 and show that polymer 5 at a dosage of 0.15 weight % relative to the dry weight of the cement composition provides a delay of about 30 minutes compared with the reference containing the cement composition without admixture. Polymer 5 at a dosage of 0.1 weight % relative to the dry weight of the cement composition in combination with sodium gluconate at a dosage of 0.08 weight % relative to the dry weight of the cement composition delay the hydration kinetics of the cement compositions by about 6 hours compared with the reference containing the cement composition without admixture. However, the set retarding agent has no impact on the intensity of the main hydration peak of the cement composition.

### EXAMPLE 4

Example with another cement composition. Impact of the type of polymer and presence of a set retarding agent on the fluidification of cement composition 2.

Tests were conducted with a cement composition 2 comprising a different type of clinker from the one previously used (out of stock), but having the mixture of metakaolin, limestone and gypsum such as described in Table 1. Having regard to the different type of clinker, the following results cannot strictly be compared with those of Tables 4 and 5 above.

The cement composition 2 used was composed of about 50% clinker and about 50% of the mixture of metakaolin, limestone and gypsum (Table 7).

TABLE 7
Minéralogical analysis by X-ray
diffraction of cement composition 2 used.

| Phase name | Formula | Weight content (%) |
|---|---|---|
| Alite | Ca₃SiO₅ | 24.7-25.7 |
| Belite | Ca₂SiO₅ | 11.6-12.6 |
| Aluminate | Ca₃Al₂O₆ | 0.9-1.9 |
| Ferrite | Ca₄Al₂Fe₂O₁₀ | 5.9-9.9 |
| Total clinker phases | | 44.1-51.1 |
| Calcium sulfate | | 7.6-8.1 |
| Quartz* | SiO₂ | 1.2-1.6 |
| Free lime* | CaO | 0.1-0.3 |
| Portlandite | Ca(OH)₂ | 0.0-0.5 |
| Calcite* | CaCO₃ | 13.5-15.0 |
| Aragonite* | CaCO₃ | 0.0-0.2 |
| Periclase* | MgO | 0.0-0.2 |
| Dolomite | CaMgCO₃ | 2.2-3.4 |
| Aphthitalite | K₃Na(SO₄)₂ | 0.0 |
| Thenardite* | Na₂SO₄ | 0.2-0.3 |
| Syngenite | K₂Ca(SO₄)₂ H₂0 | 0.0-0.7 |
| Mullite | Al₆Si₂O₁₃ | 1.8-2.0 |
| Hematite | Fe₂O₃ | 0.0 |
| Amorphous phases | | 16.2-17.4 |
| Kaolinite | Al₂Si₂O₅(OH)₄ | 2.7-3.4 |

The experimental protocol was the same as those described in Examples 1 and 2.

The ratio of the weight of water to the weight of cement composition 2 (dry weight) was 0.35.

The admixture was:
either polymer 5 (free of set retarding agent) at a dosage of 0.1 weight % relative to the dry weight of cement composition 2 to be fluidified,
or polymer 5 and sodium gluconate as set retarding agent at a dosage of 0.1 weight % of polymer 5 and 0.08 weight % sodium gluconate, each relative to the dry weight of the cement composition 2 to be fluidified,
or polymer 6 (comparative) (free of set retarding agent) at a dosage of 0.1 weight % relative to the dry weight of the cement composition 2 to be fluidified.

The results are given in Table 8.

TABLE 8
Threshold stress of admixed cement composition
2 according to type of admixture.

| | | Set | Threshold stresses (Pa) | | | | |
|---|---|---|---|---|---|---|---|
| | | retarding | 5 | 30 | 60 | 90 | 120 |
| | Admixture | agent | min | min | min | min | min |
| invention | 0.1% | none | 20.0 | 35.2 | 53.9 | 68.6 | 86.6 |
| | polymer 5 | | | | | | |
| invention | 0.1% | 0.08% | 1.6 | 0.7 | 0.8 | 1.0 | 1.0 |
| | polymer 5 | sodium | | | | | |
| | | gluconate | | | | | |
| comparative | 0.1% | none | 24.6 | 56.2 | 93.2 | 125.0 | 160.2 |
| | polymer 6 | | | | | | |

The use of 0.1 weight % of polymer 5, relative to the dry weight of the cement composition 2 to be fluidified, leads to an increase in the threshold stress of the admixed cement composition 2, whereas the use of 0.1 weight % of polymer 5 and 0.08 weight % of sodium gluconate, each relative to the dry weight of the cement composition 2 to be fluidified, allows the threshold stress to be maintained at a constant low level.

The use of 0.1 weight % of polymer 6 (comparative), relative to the dry weight of the cement composition 2 to be fluidified, leads to a stronger increase in the threshold stress of the admixed cement composition 2 than that obtained with the use of 0.1 weight % of polymer 5 (invention) relative to the dry weight of the cement composition 2 to be fluidified. Polymer 6 exhibits lower performance than polymer 5.

1. An admixed cement composition comprising:
a cement composition comprising:
from 20 to 64 weight % clinker,
from 5 to 60 weight % activated clay,
from 0 to 35 weight % limestone,
from 0 to 10 weight % calcium sulfate,
the proportions of clinker, activated clay, limestone and calcium sulfate being relative to the dry weight of the cement composition and
an admixture comprising a polymer comprising units of following formulas (I) and (II): 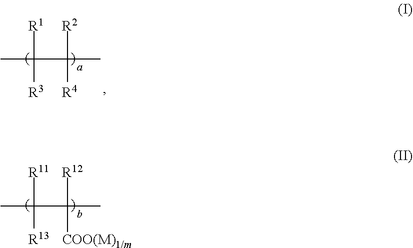
where:
R¹ and R² are each independently a hydrogen or a methyl,
R³ is a hydrogen or a group of formula —COO(M)_{1/m}
R⁴ is a group of formula —(CH₂)ₚ—(OAlk)_{q}—R⁵ where:
p is 1 or 2,
q is an integer of 3 to 300,
the Alk in each OAlk unit of the group —(OAlk)_{q}— is independently a linear or branched alkylene having 2 to 4 carbon atoms,
R⁵ is —OH or a linear or branched alkoxyl having 1 to 4 carbon atoms,
R¹¹ and R¹² are each independently a hydrogen or a methyl,
R¹³ is a hydrogen or a group of formula —COO(M)_{1/m},
M is H or a cation of valence m,
when M is H, m is 1 and when M is a cation, m is the valence of the cation M,
a is a number from 0.05 to 0.25, such that (100×a) represents the molar percentage of units of formula (I) within the polymer, and
b is a number from 0.75 to 0.95, such that (100×b) represents the molar percentage of units of formula (II) within the polymer,
the proportion of polymer in the admixture being from 0.001 weight % to 5 weight % relative to the dry weight of the cement composition.

2. The admixed cement composition according to claim 1, wherein the polymer of the admixture comprises units of following formulas (I′) and (II′): 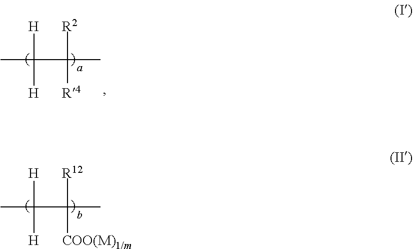
where:
R² is independently a hydrogen or a methyl,
R′⁴ is a group of formula —CH₂—(O—CH₂—CH₂)_{q}—R⁵ where:
q is an integer of 3 to 500,
R⁵ is —OH or —OMe,
a is a number from 0.05 to 0.25, such that (100×a) represents the molar percentage of units of formula (I′) within the polymer,
R¹² is a hydrogen or a methyl,
M is H or a cation of valence m,
when M is H, m is 1 and when M is a cation, m is the valence of the cation M,
b is a number from 0.75 to 0.95, such that (100×b) represents the molar percentage of units of formula (II′) within the polymer.

3. The admixed cement composition according to claim 2 wherein, in formulas (I′) and (II′) of the polymer of the admixture:
q is an integer of 5 to 200,
R⁵ is —OH or —OMe,
a is a number from 0.05 to 0.20,
b is a number from 0.80 to 0.95, and/or
M is H or a monovalent or bivalent cation, m then being 1 or 2.

4. The admixed cement composition according to claim 1, wherein the admixture comprises a set retarding agent.

5. The admixed cement composition according to claim 4, wherein the set retarding agent is gluconic acid in neutral form or a salt thereof, a phosphonic acid in neutral form or a salt thereof, or a mixture thereof.

6. The admixed cement composition according to claim 1, comprising less than 0.001 weight % of tertiary alkanolamine having 1 to 6 carbon atoms relative to the dry weight of the admixed cement composition.

7. A hydraulic composition comprising the admixed cement composition according to claim 1, water, an aggregate and optionally a mineral addition.

8. A method for improving the fluidity retention over time of a cement composition, comprising the contacting of a cement composition comprising:
from 20 to 64 weight % clinker,
from 5 to 60 weight % activated clay,
from 0 to 35 weight % limestone,
from 0 to 10 weight % calcium sulfate,
the proportions being relative to the dry weight of the cement composition, with an admixture comprising a polymer comprising units of following formulas (I) and (II): 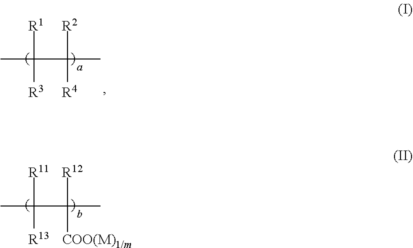
where:
R¹ and R² are each independently a hydrogen or a methyl,
R³ is a hydrogen or a group of formula —COO(M)_{1/m}
R⁴ is a group of formula —(CH₂)ₚ—(OAlk)_{q}—R⁵ where:
p is 1 or 2,
q is an integer of 3 to 300,
the Alk in each OAlk unit of the group —(OAlk)_{q}— is independently a linear or branched alkylene having 2 to 4 carbon atoms,
R⁵ is —OH or a linear or branched alkoxyl having 1 to 4 carbon atoms,
R¹¹ and R¹² are each independently a hydrogen or a methyl,
R¹³ is a hydrogen or a group of formula —COO(M)_{1/m},
M is H or a cation of valence m,
when M is H, m is 1 and when M is a cation, m is the valence of the cation M,
a is a number from 0.05 to 0.25, such that (100×a) represents the molar percentage of units of formula (I) within the polymer, and
b is a number from 0.75 to 0.95, such that (100×b) represents the molar percentage of units of formula (II) within the polymer.

9. The use method according to claim 8, wherein the admixture proportion is used so that the proportion of polymer is from 0.001 weight % to 5 weight % relative to the dry weight of the cement composition.

10. The method according to claim 8, wherein the cement composition comprises less than 0.001 weight % of tertiary alkanolamine having 1 to 6 carbon atoms relative to the dry weight of the cement composition.
